(19) United States
(12) Patent Application Publication
(10) Pub. No.: US 2022/0393267 A1
(43) Pub. Date: Dec. 8, 2022

(54) FLAME RESISTANT MATERIALS FOR ELECTRIC VEHICLE BATTERY APPLICATIONS

(71) Applicant: 3M INNOVATIVE PROPERTIES COMPANY, St. Paul, MN (US)

(72) Inventors: Bernd Kühneweg, Dusseldorf (DE); Juergen Schnusenberg, Willich (DE); Mirco Gunjaca, Nottuln (DE); Christoph Kuesters, Korchenbroich (DE); Kerstin C. Rosen, Koln (DE); Claus H.G. Middendorf, Neuss (DE); Mitchell T. Huang, Austin, TX (US); David S. Stankes, Austin, TX (US); Anne N. De Rovere, Woodbury, MN (US)

(21) Appl. No.: 17/755,471

(22) PCT Filed: Dec. 2, 2020
(86) PCT No.: PCT/US2020/062773

§ 371 Date: Apr. 29, 2022

Related U.S. Application Data
(60) Provisional application No. 62/942,284, filed on Dec. 2, 2019.

(51) Int. Cl. H01M 10/658; H01M 10/625; H01M 50/124; C09D 5/18

(52) U.S. Cl. CPC H01M 10/658; H01M 10/625; H01M 50/124; C09D 5/18; H01M 2220/20

(57) ABSTRACT

A three dimensional flame barrier is described herein. The three dimensional flame barrier comprises a flame resistant material, wherein the flame resistant barrier has a complex geometry that is defined by a height, width and length, wherein the height of the complex geometry is substantially greater than the thickness of the flame resistant material from which it is formed wherein the flame resistant material comprises inorganic fibers, inorganic particles and an inorganic binder. In some embodiments, the flame barrier article can further comprise a fire protection coating disposed on a first major surface of the flame barrier material.

### BACKGROUND OF THE INVENTION

### Field of the Invention

The present invention relates to electric vehicle battery modules and particularly to fire barrier articles for managing battery module thermal runaway incidents. The provided articles can be especially useful, for example, in automotive and stationary energy storage applications.

### Background

Today, the market and supporting technologies for battery supported hybrid or fully to electrical driven vehicles are rapidly expanding. The rechargeable batteries, including nickel metal hydride or lithium-ion batteries, are used to store energy and provide power in electric and hybrid electric vehicles. The flow of current either into the battery during recharging or out of the battery into the vehicle and its accessories generates heat. Operation outside the bounds of the specified range can damage or accelerated degradation of cells within the battery.

Electrical vehicle batteries are made up of several battery modules, and each battery module comprises many interconnected individual battery cells. When one cell in a battery module is damaged or faulty in its operation, temperatures in the cell may increase faster than heat can be removed from the module. If this temperature buildup continues unchecked, a catastrophic phenomenon called thermal runaway can occur resulting in the cell catching on fire. The resulting fire can spread very quickly to neighboring cells and then to cells throughout the entire battery in a chain reaction. These fires can be potentially massive and can spread to surrounding structures and endanger occupants of the vehicle or other structures in which these batteries are located.

When thermal runaway occurs in a cell, it is desirable for a thermal management system to block or absorb the heat and prevent adjacent cells or modules from overheating and themselves entering thermal runaway. The severe risks posed by thermal runaway event requires battery modules to be designed with thermally insulating fire barriers to mitigate the effect of the thermal runaway event and provide time for occupants to safely vacate the vehicle in the event of a fire.

Battery compartments, modules and cells can have complex geometries requiring three dimensional flame barrier solutions. Conventional flame barrier materials are typically provided in a two-dimensional sheet or board format. Typical flame barrier solutions can require multiple separate sheets of material to be used to provide a three-dimensional flame barrier solution, especially in the case of more rigid materials like mica board materials. Some of two dimensional materials may be scored, folded and/or creased to form a quasi-three dimensional shapes. However, the flame resistance of the three dimensional flame barrier solution may be diminished in the areas near creases, scoring and folds or at junctions between two abutting sheets of material.

### SUMMARY

In one aspect of the invention, a three dimensional flame barrier is described. The three dimensional flame barrier comprises a flame resistant material, wherein the flame resistant barrier has a complex geometry that is defined by a height, width and length, wherein the height of the complex geometry is substantially greater than the thickness of the flame resistant material from which it is formed wherein the flame resistant material comprises inorganic fibers, inorganic particles and an inorganic binder. In some embodiments, the flame barrier article can further comprise a fire protection coating disposed on a first major surface of the flame barrier material.

### BRIEF DESCRIPTION OF THE DRAWINGS

FIG. 1 is a schematic cross-sectional representation of a conventional three dimensional flame barrier solution.

FIG. 2 is a schematic cross-sectional representation of three dimensional flame barrier solution according to an aspect of the present invention.

FIG. 3 shows a three-dimensional molded flame resistant barrier solution according to an aspect of the present invention.

FIG. 4 shows another three-dimensional molded flame resistant barrier solution according to an aspect of the present invention.

FIG. 5 shows a portion of a three-dimensional molded flame resistant barrier solution disposed on a lid for a battery compartment according to an aspect of the present invention.

FIG. 6 shows a third three-dimensional molded flame resistant barrier solution according to an aspect of the present invention.

FIG. 7 shows a fourth three-dimensional molded flame resistant barrier solution according to an aspect of the present invention.

FIG. 8 shows a fifth three-dimensional molded flame resistant barrier solution according to an aspect of the present invention.

FIG. 9 shows a sixth three-dimensional molded flame resistant barrier solution according to an aspect of the present invention.

### DETAILED DESCRIPTION OF THE EMBODIMENTS

In the following detailed description, reference is made to the accompanying drawings, which form a part hereof, and in which is shown by way of illustration specific embodiments in which the invention can be practiced. In this regard, directional terminology, such as “top,” “bottom,” “front,” “back,” “forward,” etc., is used with reference to the orientation of the FIGS being described. Because components of embodiments of the present invention can be positioned in a number of different orientations, the directional terminology is used for purposes of illustration and is in no way limiting. It is to be understood that other embodiments can utilize structural or logical changes can be made without departing from the scope of the present invention. The following detailed description, therefore, is not to be taken in a limiting sense, and the scope of the present invention is defined by the appended claims.

As used herein, “complex geometry” refers to three-dimensional structures having a plurality of sections made up of one or more two-dimensional sections and one or more three dimensional sections. The three-dimensional structures can be characterized by a length, a width, and a depth of the three dimensional structure as well as the thickness of the structure. In some embodiments of the invention, the three-dimensional structures of the exemplary articles described herein can have generally uniform thickness across the structure such that the thickness of the flame barrier material at any point in the structure T_{xyz} is within +/−30% of the average material thickness for flame barrier material. In some embodiments, the average thickness of the flame barrier material in the three-dimensional shaped flame barriers described herein can be between 0.1 mm and 10 mm, preferably between 0.2 mm and 5 mm. In some embodiment, the complex geometry can be created by the shaping a two-dimensional sheet of flame barrier material into a self-supporting three-dimensional shape by bending and folding of the two dimensional sheet without creating a permanent crease or fold in the flame barrier material. In other embodiments, the complex geometry of the three-dimensional shaped flame barrier can include areas or regions where the thickness of the flame barrier materials has been purposely increased such as in areas where stresses might concentrate or heat could be more intense such as in raised areas, at corners or edges between two non-coplanar adjoining sections. When thickness has been purposely increased or decreased, thickness difference between sections can be larger than 30%.

As used herein, “self-supporting” refers to structures to a three dimensional structure capable of maintaining its shape without supplemental support.

Protecting against the dangers associated with a sudden fire during a thermal runaway event is a significant technical challenge, especially when dealing with complex geometries in a battery compartment module or between cells. Attempting to create a universal solution is difficult to achieve because protecting against one characteristic of a battery fire may cause other types of problems.

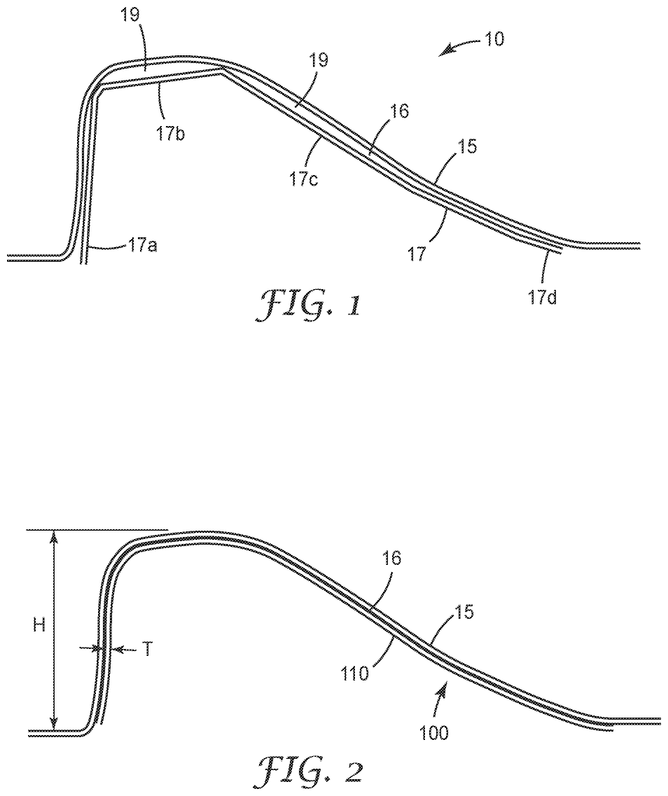

For example, FIG. 1 is a schematic cross-sectional representation of a conventional three dimensional thermal barrier solution 10 illustrating how multiple two-dimensional flame barrier sheets 17a-17d (collectively barrier sheet 17) may be required to fully protect a battery compartment component 15 having complex geometry. Even with the use of several sheets, there may be air gaps 19 between the battery compartment component and the barrier sheet 17. Generally, battery compartments are designed to exacting specs that typically would not allow air gaps, thus flame barrier materials which do not conform to the interior surface of the battery compartment may not be usable in some applications. Having air gaps between the walls of the battery compartment component and the flame barrier can allow air to circulate through the gaps during a thermal runaway event leading to premature break-through diminishing the effectiveness of the thermal barrier. Premature failure or delamination of the thermal barrier may occur as a result of stress concentration at the points around the airgaps where the flame barrier contacts the walls of the battery compartment component through normal use (i.e. due to vibration, thermal mismatch, shifting of cells, modules or other components in the battery compartment, etc.). Additionally, adhesives or tapes (not shown) may be required to mount each barrier sheet to the inner surface 16 of the battery compartment component. As mentioned previously, the flame resistance of the three dimensional flame barrier solution may be diminished in the areas near or at junctions between two abutting sheets of material.

More recently, thermal barrier materials having a greater degree of flexibility have been explored to improve conformability to battery compartment geometries, such as described in PCT Publication No. WO 2020/023357. However, these materials are still produced and provided as two-dimensional sheets of material.

In contrast, the present invention provides a three-dimensional shaped flame barrier 100 as illustrated schematically in FIG. 2. In this exemplary solution, flame barrier material 110 has be molded such that the flame barrier material 110 substantially conforms to the inner surface 16 of the battery compartment component 15. In one exemplary aspect, flame barrier material 110 can be formed/molded directly onto the surface 16 of the battery compartment component 15. In another aspect, flame barrier material 110 can be molded in a separate operation and joined to the battery compartment component during assembly of the battery pack.

In some exemplary embodiments, flame barrier material 110 can be an electrical insulating material having compositions similar to those described in PCT Publication No. WO 2020/023357, incorporated herein in its entirety. Flame barrier material 110 can be thermally and electrically insulating and in the form of an inorganic insulating paper or board. Multiple sheets, i.e., plies or sub-layers of inorganic paper layer may be wet laminated and pressed to yield an inorganic board or a multilayer paper material that is thermally and electrically insulating. The term “paper” refers to a flexible single or multilayer material that has sufficient flexibility to be bent around a 3-in. mandrel. The term “board” refers to a relatively stiff material that can be flexed, but which is not capable to wrap around a mandrel. The term “three-dimensional shaped flame barrier” refers to a semi-rigid, nonplanar, molded flame barrier material that is substantially form fitting to the battery compartment component to which it is applied.

Exemplary flame resistant material can have a density less than mica. In some embodiments, the exemplary flame resistant material can have a density less than 1.5 g/cm³.

In particular, the exemplary three-dimensional shaped flame barrier comprises a flame resistant material, wherein the flame resistant barrier has a complex geometry that is defined by a height, H, width and length, wherein the height of the complex geometry is substantially greater than the thickness, T, of the flame resistant material from which it is formed as shown in FIG. 2.

Flame barrier material 110 comprise a combination of inorganic fibers and inorganic particles may be referred to as inorganic papers or boards depending on thickness and flexibility of the insulating material. The flame resistant substrate layer 110 are largely made up of inorganic materials (i.e. inorganic fibers and fillers). In an exemplary embodiment flame barrier material 110 comprise at least 95% inorganic materials. In an exemplary embodiment, flame barrier material 110 comprise at least 96% inorganic materials. The highly inorganic nature of the exemplary flame resistant substrate layer enhances the flame resistance of these materials over most conventional insulating papers.

In some embodiments, flame barrier material 110 comprises inorganic fibers, inorganic particles and an inorganic binder. Exemplary inorganic fibers may be selected from the group of glass fibers e.g. (E-glass fibers, S-glass fibers, R-glass fibers, ECR-glass fibers, etc.), basalt fibers, ceramic fibers, polycrystalline fibers, silicate fibers, alumina fibers, silica fibers, carbon fibers, silicon carbide fibers, boron silicate fibers or a combination thereof. More specifically, the fibrous material may include annealed melt-formed ceramic fibers, sol-gel formed ceramic fibers, polycrystalline ceramic fibers, alumina-silica fibers, glass fibers, including annealed glass fibers or non-bio-persistent fibers. Other fibers are possible as well, if they withstand the high temperatures generated in a thermal event of a Li-ion battery.

The exemplary flame barrier material can comprise a combination of glass fibers and microglass fibers. These fibers interlock together to form the structural support of the inorganic fillers. The glass fiber content of the flame barrier material will be from about 3 wt. % to 25 wt. %, with the ratio of glass staple fibers to micro glass fibers being 5:1 to 1:3.

The diameter of the glass fibers can affect the processing of the paper, as well as the final performance of the resulting flame barrier material. Exemplary glass staple fibers diameters are 12 microns or less, although small amounts of larger diameter fibers may be incorporated. Smaller diameter glass fibers have a greater surface area than an equivalent amount of larger diameter fibers enabling entrapment of an increase amount of particulate filler materials. The microglass fibers used in the present invention typically have a diameter of less than 5 microns. The working diameter range for the glass fibers and glass microfibers is from about 0.1 micron to about 12 microns.

The length of the glass fibers is selected to obtain a uniform dispersion of the glass fibers in the slurry used to make the exemplary flame barrier material. It is noted that if the glass fibers are too short there may not be sufficient interlocking between the fibers, and the strength of the resulting material may be diminished. If the glass fibers are too long, it can be difficult to obtain the uniform dispersion needed. Thus, the glass fibers should have an average length less than 0.5 inch (12,700 microns) and more preferably about 0.25 inch (6350 microns) and greater than 0.125 inch (3175 microns).

The glass fibers may also be further identified by a length-to-diameter (L/D) ratio. The exemplary L/D ratio for the glass staple fibers used in the exemplary flame barrier materials are between 3000:1 and 200:1, preferably about 1000:1.

In at least one embodiment of the present invention, the nonwoven flame barrier material also comprises one or more inorganic particulate fillers. Suitable inorganic particulate fillers include, but are not limited to, glass bubbles, kaolin clay, talc, mica, calcium carbonate, alumina trihydrate, montmorillonite, smectite, bentonite, illite, chlorite, sepiolite, attapulgite, halloysite, vermiculite, laponite, rectorite, perlite, and combinations thereof. Suitable types of kaolin clay include, but are not limited to, water-washed kaolin clay; delaminated kaolin clay; calcined kaolin clay; and surface-treated kaolin clay.

The particulate inorganic filler content of the flame barrier material will be from about 65 wt. % to 87 wt. %. In the exemplary flame barrier material of the present invention comprise a mixture of particulate inorganic fillers. For example, the exemplary flame barrier materials comprise between about 20 wt. % to 65 wt. % of kaolin clay, from about 25 wt. % to 55 wt. % mica, and from about 0 wt. % to 15 wt. % glass bubbles based on the total weight of the exemplary flame barrier material.

The exemplary flame barrier materials further comprise 5 wt. % - 20 wt. %, preferably 5 wt. %-15 wt. % inorganic binder. The inorganic binder can be selected from sodium silicate, potassium silicate or a combination thereof.

In some embodiments, the exemplary flame barrier materials further may further comprise 0 wt. % to 5 wt. % polymer fibers, preferably 1 wt. % to 5 wt. % polymer fibers. Exemplary polymer fibers should be flame retardant. Suitable polymer fibers include acrylic fibers, m-aramid fibers, p-aramid fibers, aramid fibrids, fluoropolymer fibers, oxidized polyacrylonitrile materials and the like. In an exemplary aspect the polymeric fibers have dimensions of 2 denier×6 mm. In some embodiments, the polymer fibers are m-aramid fibers. Even small additions of polymeric fibers have been found to improve processability, moldability and elongation properties of the exemplary flame barrier materials.

Additional materials such as defoamers, surfactants, forming aids, pH-adjusting materials, etc., known to those skilled in the art, can also be incorporated.

Exemplary three-dimensional shaped flame barriers can be made by a modified papermaking process or by a modified pulp molding process. In some aspects, the modified pulp molding process can be a vacuum assisted molding process, while in other aspects the molded material can be dewatered without vacuum.

Conventional pulp molding processes used to manufacture cellulose based packaging products and food-related carriers. Pulp molding generally involves mixing the cellulose-based paper ingredients with water to form a slurry, forming the three dimensional article on a mesh form, dewatering the slurry using vacuum to remove a portion of the water, optionally pressing the preformed part in a mold to compress the fibrous paper material together and drying the part or the compressed part in the mold or in an oven.

In an alternative pulp molding process, a slurry of the paper forming materials are dispersed in water. The slurry is introduced into a first section of a mold. A corresponding second section of the mold is closed over the first section wherein at least one of the first and second sections of the mold includes moisture egress channels to allow moisture to escape during dewatering of the slurry. The sections of the mold are held together under pressure and heated to facilitate dewatering. After the majority of the water has been removed, the 3D article is removed from the mold. In some instances, it may be desirable to place the molded article in an oven to complete the drying process.

One advantage of either of the pulp molding processes is that they can allow creation of a three-dimensional shaped flame barrier article having a customized thickness profile allowing form greater thicknesses of the flame barrier material in critical areas which could be subjected to excessive stresses, heat or shrapnel during a thermal runaway event or other events during the lifetime of the part.

The modified paper making process used standard paper making equipment to make a two dimensional sheet of flame barrier precursor material. The flame barrier precursor material follows the standard process through the dewatering step where it is then transferred onto a three-dimensional form and molded under pressure and or elevated temperature and then dried either in the mold or in an oven.

After molding the exemplary three-dimensional shaped flame barriers retain their three dimensional shape.

In one aspect of the present invention, a three-dimensional shaped flame barrier is provided that comprises a formed flame barrier material having a first major surface and a second major surface, and a fire protection coating disposed on a substantial portion of the first major surface of the flame barrier material.

The fire protection coating layer can be formed by applying an exemplary coating composition applied by spraying, painting, or the like. The exemplary coating composition of the present invention comprises an inorganic binder and at least one inorganic filler. The exemplary coating composition can be a solvent based coating or an aqueous based coating, preferably an aqueous based coating composition. Exemplary coating compositions are described in commonly assigned U.S. Provisional Application No. 62/942,279, “Flame Resistant Materials for Electric Vehicle Battery Applications”, filed on Dec. 2, 2019, incorporated herein in its entirety.

Exemplary inorganic binders include sodium silicate, potassium silicate or a combination thereof In some embodiments, the inorganic binder can be a polysilicate having the formula M₂O(SiO2)ₙ.H₂O, wherein M is selected from Li, Na, K, preferably K or Na and n is an integer between 1 and 15, preferably between 3 and 9. It is further preferred that the polysilicate is employed in a solvent, preferably water. In other embodiments, the inorganic binder can be Na₂SiO₃. The exemplary coating composition comprises 10 wt. %-80 wt. % inorganic binder based on the percent solids in the dried coating, preferably 20 wt. %-60 wt. % inorganic binder.

The particulate inorganic filler content in the coating composition will be from about 20 wt. %-90 wt. % based on the percent solids in the dried coating, preferably 40 wt. %-80 wt. %. Exemplary inorganic fillers include, but are not limited to kaolin clay, glass beads or bubbles, talc, mica, mullite, phlogopite, muscovite montmorillonite, smectite, bentonite, illite, chlorite, sepiolite, attapulgite, halloysite, vermiculite, laponite, rectorite, perlite, and combinations thereof. Suitable types of kaolin clay include, but are not limited to, water-washed kaolin clay; metakaolin clay, delaminated kaolin clay; calcined kaolin clay; and surface-treated kaolin clay.

In some embodiments, an organic binder material can be added to the exemplary coating composition. Exemplary polymeric binders include (meth)acrylic binders, rubber-based binders, styrene acrylic binders, styrene butadiene binders, urethane acrylate binders, silicone binders, binders based on vinyl polymers, epoxy binders and the like. In exemplary embodiments, the to polymeric binders can be provided as waterborne polymer dispersions.

In some embodiments, additives can be added to the exemplary coating composition. Exemplary additives include defoamers, surfactants, rheological modifiers, forming aids, pH-adjusting materials, etc. Exemplary rheological modifiers can be an organic compound, preferably wherein the organic compound is selected from polysaccharides, proteins and polyvinyl alcohols, preferably are selected from natural and modified polysaccharides, preferably polysaccharides selected from the list consisting of xanthan, carrageenan, pectin, gellan, xanthan gum, diuthan, cellulose ethers such as carboxymethyl cellulose, methyl cellulose, ethyl cellulose and hydroxyethyl cellulose.

As mentioned previously, the fire protection coating composition may be applied to the first major surface of a flame resistant substrate layer to form exemplary three-dimensional shaped flame barrier that can be used as a protective device or system, such as a thermal/flame barrier. For example, an exemplary three-dimensional shaped flame barrier can be incorporated into or wrapped around a flammable energy storage device, such as lithium ion battery cells, modules, or packs, such as may be found in hybrid or electric vehicles or other electric transportation applications or locations. In other applications, the exemplary three-dimensional shaped flame barrier can be used as a lid/pack liner for said flammable energy storage devices.

The exemplary three-dimensional shaped flame barrier of the present invention should prevent heat from flowing from a failing cell or module to an adjacent cell or module or the passenger compartment. For example, the exemplary three-dimensional shaped flame barrier should provide a high thermal gradient or temperature drop across the material when exposed to high temperature on one side of the material. In an alternative, the exemplary three-dimensional shaped flame barrier may be used as a thermal barrier lid in an electric vehicle battery pack that can prevent or reduce the rate of heat flow out of the battery pack.

### EXAMPLES

These examples are for illustrative purposes only and are not meant to be limiting on the scope of the appended claims. All parts, percentages, ratios, etc. in the examples and the rest of the specification are by weight, unless otherwise noted.

### Test Methods

### Sandblast Test:

Samples were pre-conditioned at 25°C. or at either 1000°C. or 1200°C. for 10 min in an oven to simulate a thermal runaway event.

For the sandblast test a commercially available sandblast cabinet is used such as a Professional Sand Blasting Desktop Cabinet, from PowerPlus Tools GmbH, (Germany). The sample material is mounted to a metal sheet sample holder having the dimensions of 100 mm by 50 mm. A sample having dimensions of 80 mm by 50 mm is fixed with a masking tape on all sides to the metal sheet. A fixture inside of the cabinet holds the samples in a defined position in front of the nozzle. Compressed air is used to accelerate the sandblast media (Type 211 glass beads, grain size 70-110 μm) against the surface of the sample until the test specimen (i.e. the sample) has been damaged in an area of 4+/−1 mm diameter, and the elapsed time of the test is recorded. In addition, normalized abrasion resistance values are calculated by normalizing the elapsed exposure time by the thickness/caliper of the sample. Exemplary results can be found in Tables 3-5.

### Materials

### Materials for the Flame Barrier Material (FBM)

EC6-6 E-glass chopped strand fibers (6 mm length, 6 μm diameter), available from Lauscha Fiber International Corporation (Charlotte, N.C., USA).

B-06-F microglass fibers (0.65 μm diameter, 2.47 m²/g surface area), available from Lauscha Fiber International Corporation (Charlotte, N.C., USA).

110X-481 microglass fibers available from Johns Manville (Waterville, Ohio, USA).

M-aramid fibers (2 denier, 6 mm length), available from Aramid HPM, LLC (Hilton Head, S.C., USA).

Suzorite 200-HK phlogopite mica, available from Imerys (Boucherville, Quebec, CA).

Delaminated kaolin clay Hydraprint, available from Kamin LLC (Macon, Ga., USA).

Calcined kaolin clay Kamin 70C, available from Kamin LLC (Macon, Ga., USA).

Kaolin clay Kamin HG90, available from Kamin LLC (Macon, Ga., USA).

HTS B214 MicroLite Vermiculite Dispersion, available from Specialty Vermiculite (Enoree, S.C., USA).

N-sodium silicate, available from PQ Corporation (Valley Forge, Pa., USA).

K-sodium silicate, available from PQ Corporation (Valley Forge, Pa., USA).

### Materials for Inorganic Coating Compositions

KASIL® 2130 Potassium silicate solution (MR>3.2; 30% Solids), available from National Silicates (Germany).

Sodium Silicate Solution, extra pure, available from Merck KGaA (Germany).

ACRONAL® S980S Acrylic Polymer Dispersion (50% Solids), available from BASF (Ludwigshafen, Germany).

KELTROL® BT Xanthan Gum, available from CP Kelco (Atlanta, GA, USA).

Poly(vinyl alcohol), 95% hydrolyzed, average M.W. 95000, also available from Fisher Scientific AG (Switzerland).

CELLOSIZE ^{TM} QP100MH Hydroxyethyl Cellulose, available from Dow Chemical Company (Midland, MI, USA).

METAPOR® MVV Metakaolin, available from Dennert Poraver GmbH, (Germany).

SYMULOX® M72 Synthetic Sintered Mullite, available from Nabaltec (Germany).

Phlogopite Mica, available from Georg.H.Luh GmbH (Germany).

Aspaga Mica, available from Aspager Bergbau and Mineralwerke GmbH&Co KG (Germany).

Creating a Three-Dimensional shaped Flame Barrier by a 2D-Shaping Process

A mixture of 3.5 wt. % EC6-6 E-glass fibers (6 mm length, 6 μm diameter), 3.9 wt. % m-aramid fiber, 1.6 wt. % B-06-F microglass fibers (0.65 μm diameter, 2.47 m²/g), 28.0 wt. % 200-HK phlogopite mica, 21.0 wt. % calcined kaolin clay Kamin 70C, were pre-dispersed in water to form an aqueous slurry with a solids content of about 0.05-1% by weight in a Waring blender and then mixed into a larger container with 33.0 wt. % delaminated kaolin clay Hydraprint and 9.0 wt. % N-sodium silicate. Additional materials such as defoamers, surfactants, forming aids, pH-adjusting materials, known to those skilled in the art can also be incorporated. Dewatering was done through a papermaking screen and press (Williams Standard Pulp Testing Apparatus) to form a precursor sheet of flame resistant material. The precursor sheet of flame resistant material was applied onto the surface of a three-dimensional substrate and dried to create a three-dimensional molded flame resistant barrier.

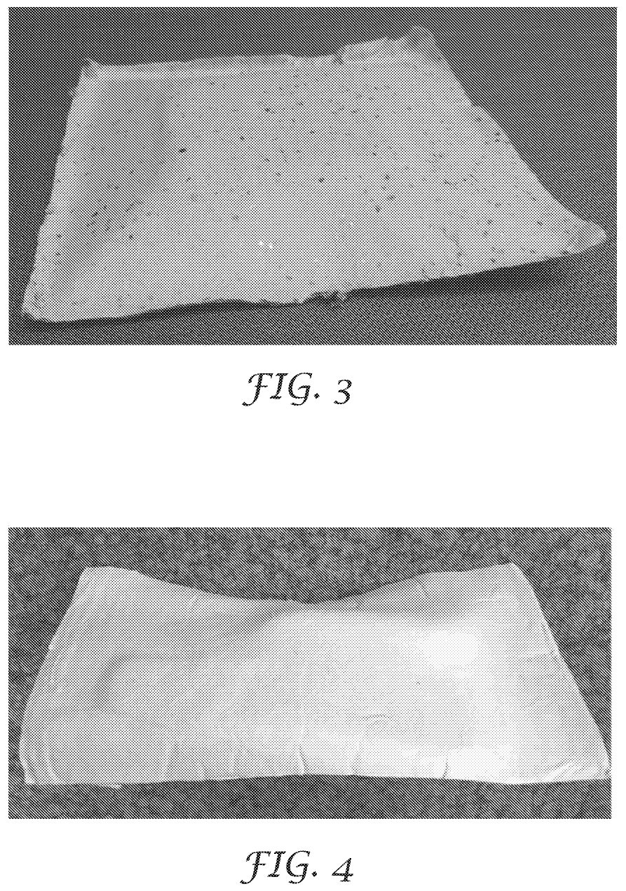

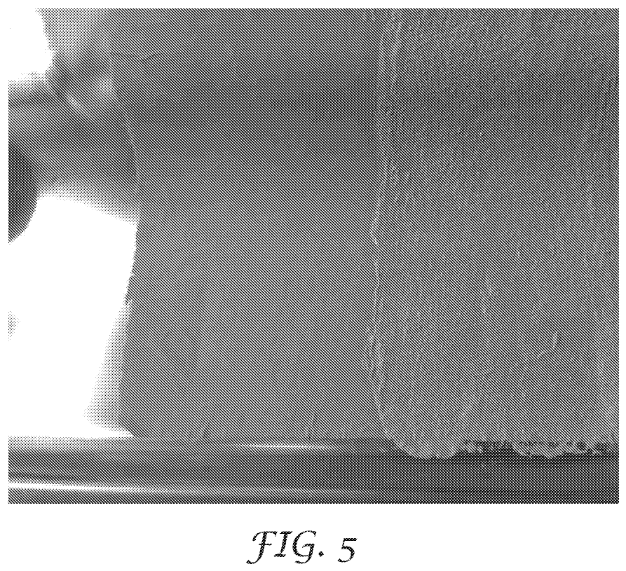

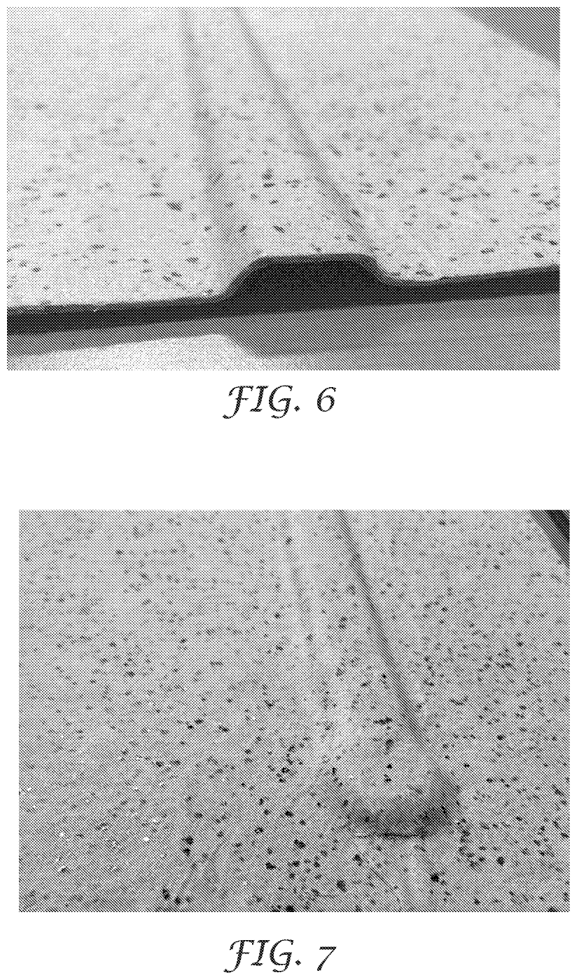

FIGS. 3, 4, 6 and 7 show four three-dimensional molded flame resistant barriers having different surface profiles.

### Creating a Three-Dimensional Shaped Flame Barrier by a 3D-Molding Process

An inorganic paper slurry was made comprising of 3.5 wt. % EC6-6 E-glass fibers (6 mm length, 6 μm diameter), 3.9 wt. % m-aramid fiber, 1.6 wt. % B-06-F microglass fibers (0.65 μm diameter, 2.47 m2/g), 28.0 wt. % 200-HK phlogopite mica, 21.0 wt. % calcined kaolin clay Kamin and 33.0 wt. % delaminated kaolin clay Hydraprint and 9.0 wt. % N-sodium silicate in water, wherein the solids content of the slurry was about 70%.

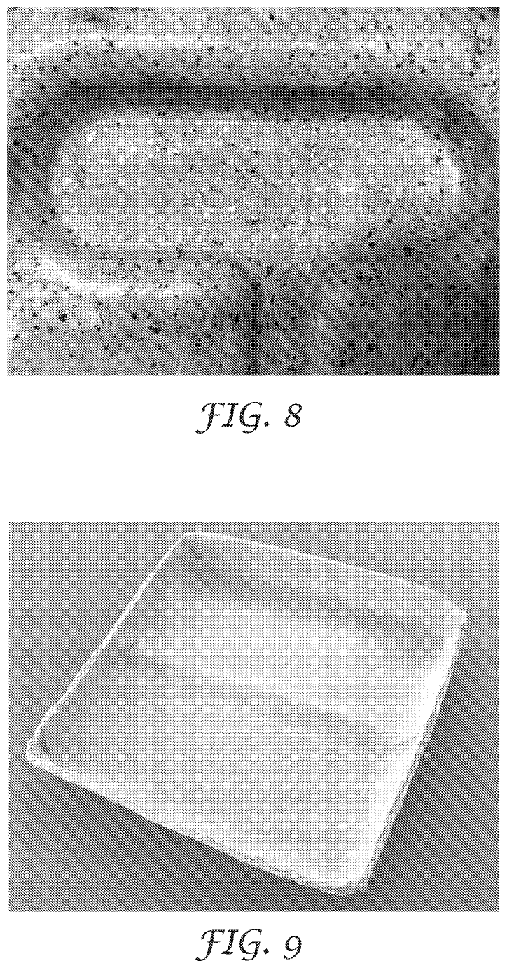

A mold was preheated to 90° C. and treated with a wax mold release agent. The slurry was spread evenly in a first section of the mold and closed with the second section of the mold. Dewatering was carried out in the heated mold at 90° C. for 25 minutes with the water/water vapor exiting the mold through water vapor egress channels. After dewatering, the mold was opened, and the 3D article was removed. FIG. 8 shows three-dimensional shaped flame barrier produced.

### Creating a Three-Dimensional Shaped Flame Barrier by a 3D-Vacuum Assisted Molding Process

An inorganic paper slurry was made comprising 12 g of glass microfiber (110X-481) from Johns Manville and 30 g of KaMin HG90 clay were pulped on HIGH for 60 sec in a Waring blender in 2 L of water. After pulping, the slurry was transferred to a mixing bowl, and 62 g of vermiculite dispersion MicroLite HTS B214, 10.7 g of K Sodium silicate from PQ Corporation and 3 L of water were added. The slurry was transferred to a rectangular bucket about 14″×12″.

A three-dimensional article was formed on a perforated 3D mold (first section) covered with a stainless steel wire mesh and connected to a vacuum cleaner. The wire mesh allowed water to pass through while retaining the solid components of the slurry. Vacuum was applied for a few seconds (˜5 sec) to create a wet pulp layer on the wire mesh. A thin shrink wrap plastic film was placed on top of the wet pulp layer, and vacuum was applied again to remove additional water. The part was pressed into the second section of the mold to remove more water and to smooth the surface of the part not in contact with the metal screen. The three-dimensional part was partially dried while still supported by the mold in an oven at 100° C. The partially dried three-dimensional part, which was now self-supporting, was removed from the mold and drying was completed at 140° C. Part weight was 13.7 g.

### Coating Compositions

The binder material(s) was placed in a mixing vessel. The inorganic particles were ground and sieved to produce particles having an average particle size of 10 microns. The sieved particles were added to the binder solution to yield a homogeneous coating.

The composition information is provided in Table 1 and Test data provided in Tables 3 and 4 for the coatings of examples 1-7. The composition information for examples 8-12 is provided in Table 2 and Test data provided in Table 5.

### Examples 5-7

The binder material(s) was placed in a mixing vessel and the rheology modifier was added and stirred until the rheology modifier dissolved. The inorganic particles were ground and sieved to produce particles having an average particle size of 10 microns. The sieved particles were added to the binder solution to yield a homogeneous coating. The composition information is provided in Table 1 for the coatings of examples 5-7.

TABLE 1
Potassium silicate based inorganic coating compositions
(all values are provided percent solids in the dried coating)

| | | C1 | Ex. 1 | Ex. 2 | Ex. 3 | Ex. 4 | Ex. 5 | Ex. 6 | Ex. 7 |
|---|---|---|---|---|---|---|---|---|---|
| Potassium Silicate | Binder | 100 | 42.9 | 42.9 | 18.8 | 18.8 | 42.4 | 42.4 | 42.7 |
| Acronal S980S | Binder | | | | 31.2 | 31.2 | | | |
| Metakaolin | Particle | | 57.1 | | 50.0 | | 56.6 | 56.6 | 56.9 |
| Mullite | Particle | | | 57.1 | | 50.0 | | | |
| Keltrol BT | Rheology | | | | | | 1.0 | | |
| | modifier | | | | | | | | |
| PVA 95T/95% | Rheology | | | | | | | 1.0 | |
| | modifier | | | | | | | | |
| Cellosize | Rheology | | | | | | | | 0.4 |
| QP100MH | modifier | | | | | | | | |

TABLE 2
Additional Inorganic coating compositions
(all values are provided percent solids in the dried coating)

| | | Ex. 1 | Ex. 8 | Ex. 9 | Ex. 10 | Ex. 11 | Ex. 12 |
|---|---|---|---|---|---|---|---|
| Potassium Silicate | Binder | 42.9 | 42.8 | 42.8 | | | |
| Sodium Silicate | Binder | | | | 42.9 | 42.8 | 42.8 |
| Metakaolin | Particle | 57.1 | 28.6 | 28.6 | 57.1 | 28.6 | 28.6 |
| Mullite | Particle | | | | | | |
| Phlogopite | Particle | | 28.6 | | | 28.6 | |
| Aspaga Mica | Particle | | | 28.6 | | | 28.6 |

The exemplary coating compositions were coated on a sheets of flame resistant paper (FRP) described above or flame resistant boards (FRB) for flame resistance/shrapnel testing. The flame resistance boards (FRB) used is the flame resistant board described in Example 8-B in International Application No. PCT/US2019/042776. Uncoated flame resistant paper FRB or boards were used as control samples. Test results for the exemplary compositions of Tables 1 and 2 are provided in provided in Tables 3-5.

TABLE 3
Properties of exemplary coatings disposed on flame resistant paper (FRP)

| | 25° C. Pretreatment | | | 1200° C. Pretreatment | | | |
|---|---|---|---|---|---|---|---|
| | Caliper | Time | Resistance | Caliper | Time | Resistance | Wt. % coating in |
| Sample | (mm) | (s) | (s/mm) | (mm) | (s) | (s/mm) | coated paper |
| C1 | 0.45 | 71 | 158 | 0.60 | 3 | 5 | 41 |
| Ex. 1 | 1.10 | 85 | 77 | 0.60 | >360 | 600 | 42 |
| Ex. 2 | 0.60 | 70 | 117 | 0.60 | >360 | 632 | 41 |
| Ex. 3 | 1.06 | 399 | 376 | 0.58 | 120 | 207 | 50 |
| Ex. 4 | 0.70 | 352 | 503 | 0.60 | 26 | 43 | 42 |
| Uncoated | 0.39 | 60 | 154 | 0.57 | 12 | 21 | 0 |
| paper | | | | | | | |

TABLE 4
Properties of exemplary coating compositions disposed on a flame resistant board

| | 25° C. Pretreatment | | | 1200° C. Pretreatment | | | |
|---|---|---|---|---|---|---|---|
| | Caliper | Time | Resistance | Caliper | Time | Resistance | Wt.% coating in |
| Sample | (mm) | (s) | (s/mm) | (mm) | (s) | (s/mm) | coated paper |
| C1 | 120 | 71 | 18 | 2.00 | >300 | 150 | 25 |
| Ex. 1 | 1.65 | 85 | 26 | 2.50 | >300 | 120 | 43 |
| Ex. 2 | 1.30 | 70 | 22 | 2.00 | 73 | 37 | 29 |
| Ex. 3 | 1.65 | 399 | 70 | 2.00 | >300 | 150 | 49 |
| Ex. 4 | 1.30 | 352 | 43 | 2.00 | >300 | 150 | 38 |
| Uncoated | 1.20 | 60 | 5 | 1.20 | >300 | 294 | 0 |
| Board | | | | | | | |

The coating compositions transformed into a ceramic-like layer when subjected to the high temperature preconditioning at 1200° C. which generally provided improved abrasion resistance to the coated articles.

TABLE 5
Properties of additional coating compositions disposed on a
flame resistant paper board (FRB)

| | 1000° C. Pretreatment | | | 1200° C. Pretreatment | | | |
|---|---|---|---|---|---|---|---|
| | Caliper | Time | Resistance | Caliper | Time | Resistance | Wt. % coating in |
| Sample | (mm) | (s) | (s/mm) | (mm) | (s) | (s/mm) | coated paper |
| Ex. 1 | 1.00 | 17 | 17 | 0.60 | >300 | >500 | 43 |
| Ex. 8 | 0.71 | 15 | 21 | 0.40 | >300 | >700 | 40 |
| Ex. 9 | 0.94 | 15 | 16 | 0.90 | >300 | >334 | 40 |
| Ex. 10 | 1.23 | 83 | 67 | 1.10 | >300 | 151 | 45 |
| Ex. 11 | 1.20 | 209 | 174 | 1.09 | >300 | >275 | 47 |
| Ex. 12 | 1.22 | 47 | 39 | 1.12 | >300 | >268 | 46 |

FIG. 5 shows an exemplary three-dimensional shaped flame barrier wherein a three-dimensional molded flame resistant paper is coated with the coating composition EX. 3.

Various modifications of the exemplary electrical insulating materials described herein including equivalent processes, as well as numerous structures to which the present invention may be applicable will be readily apparent to those of skill in the art to which the present invention is directed upon review of the present specification.

1. A three-dimensional shaped flame barrier comprising:
a flame resistant material, wherein the flame resistant barrier has a complex geometry that is defined by a height, width and length, wherein the height of the complex geometry is substantially greater than the thickness of the flame resistant material from which it is formed,
wherein the flame resistant material comprises inorganic fibers, inorganic particles and an inorganic binder.

2. The shaped flame barrier of claim 1, wherein the inorganic fibers are glass fibers.

3. The shaped flame barrier of claim 2, wherein glass fibers comprise glass staple fibers and micro glass fibers in a ratio of glass staple fibers to micro glass fibers is 5:1 to 1:3.

4. The shaped flame barrier of claim 1, wherein the inorganic particles comprise a mixture of 20 wt. % to 65 wt. % of kaolin clay, 25 wt. % to 55 wt. % mica and 0 wt. % to 15 wt. % glass bubbles based on the composition of the insulating material.

5. The shaped flame barrier of claim 1, wherein the inorganic binder comprises at least one of sodium silicate and potassium silicate.

6. The three-dimensional shaped flame barrier of claim 1, wherein the flame resistant material further comprises 1-5 wt. % organic fibers.

7. The three-dimensional shaped flame barrier of claim 6, wherein the organic fibers are flame retardant polymeric fibers.

8. The three-dimensional shaped flame barrier of claim 6, wherein the organic fibers are m-aramid fibers.

9. The three-dimensional shaped flame barrier of claim 1, wherein the flame resistant material has a density less than mica's density.

10. The three-dimensional shaped flame barrier of claim 1, wherein the flame resistant material has a density less than 1.5 g/cm³.

11. The three-dimensional shaped flame barrier of claim 1, wherein the flame resistant material further comprises a fire protection coating disposed on at least one surface of the shaped flame barrier, wherein the fire protection coating comprises:
an inorganic binder, and
at least one inorganic filler,
wherein the inorganic binder is selected from potassium silicate, sodium silicate, or a combination thereof, and
wherein the at least one inorganic filler is selected from glass bubbles, kaolin clay, talc, mica, calcium carbonate, alumina trihydrate, mullite, phlogopite, muscovite montmorillonite, smectite, bentonite, illite, chlorite, sepiolite, attapulgite, halloysite, vermiculite, laponite, rectorite, perlite, and combinations thereof.

12. The three-dimensional shaped flame barrier of claim 1, wherein the shaped flame barrier is configured to be applied to a nonplanar substrate.

13. The three-dimensional shaped flame barrier of claim 1, wherein the shaped flame barrier is a flame resistant liner for a battery compartment.

14. The three-dimensional shaped flame barrier of claim 1, wherein the three-dimensional shaped flame barrier is self-supporting.
